(19) United States
(12) Patent Application Publication
(10) Pub. No.: US 2011/0108373 A1
(43) Pub. Date: May 12, 2011

(54) BICYCLE CRANK LOCK

(75) Inventor: Christopher Charles Toal, Auckland (NZ)

(73) Assignee: Cranklock Limited, Auckland (NZ)

(21) Appl. No.: 12/991,640

(22) PCT Filed: May 8, 2009
(86) PCT No.: PCT/NZ09/00070

§ 371 Date: Jan. 24, 2011

(30) Foreign Application Priority Data
May 9, 2008 (NZ) 568191
Dec. 22, 2008 (NZ) 573858
Mar. 19, 2009 (NZ) 575644

(51) Int. Cl. B62L 3/02; F16D 65/34; F16C 1/10; F16D 49/02; F16D 51/10; F16D 55/02

(52) U.S. Cl. 188/31; 188/77 R; 188/78; 188/71.1

(57) ABSTRACT

This invention relates to a bicycle crankshaft lock comprising a lock engageable with the crankshaft of a bicycle, the bicycle crankshaft rotatable when the lock is moved to a crankshaft non-engaged position, the lock inoperative condition, and the bicycle crankshaft non-rotatable when the lock is moved to a crankshaft engaged position, the lock operative condition, and an actuator is connectable to the lock and operable to engage the lock with the crankshaft between the inoperative and operative conditions, the actuator being hand operable by a user.

### FIELD OF THE INVENTION

The present invention relates to a bicycle crankshaft lock.

### BACKGROUND TO THE INVENTION

When steering a bicycle or a motorcycle, to turn one way for example, to turn right, you initially steer to the left and lean your body weight to the right resulting in the bicycle turning right. This occurs because as the rider leans the leaning torque overrides the torque and the system angle steering eventually turns right resulting in a right turn.

To maintain high cornering speeds on a motorcycle, the rider relocates their body mass to a stable position on the inside of the motorcycle in relation to the corner. This relocates the point of moment internally to the radius of the corner to increase the mass applied to the transaction surfaces of the tyres. The rider performs this manoeuvre by means of weight bearing pins or pegs fixed to the motorcycle frame at approximately midway between the front and rear wheels and as low as practical so as not to interfere high on leans.

In the case of ordinary bicycles, this mass relocation is not able to be taken advantage of to the same extent. Bicycle locomotion is provided by the riders limbs locating around a driving crankshaft and for this reason, such pins or pegs would be impossible to locate in the appropriate position. The pins or pegs would prevent the free movement of the feet through the lower and upward strokes of the driving motion. In addition, unlike a motorcycle, the riders mass far exceeds that of the bicycle so the placement of the riders mass is more critical than in the motorcycle situation.

Current bicycle design reduces the opportunity for riders to use their mass to maximum advantage when cornering. This is because weight transfer is only able to occur after the rider achieves stability on at least three or four flexible points.

The problem areas are:

The handlebars are located by a shaft suspended in friction reducing bearings to ease rotation of the axes in the vertical plane.

The pedals are mounted on rotating shafts suspended in friction reducing bearings that are fixed to the drive shaft by connecting rods. The driveshaft is set in horizontal plain also suspended in bearings to facilitate ease or rotation of the drive force.

For steering stability rider mass is required to be applied downwards through the handlebars via a head stem, this raises and widens the centre of gravity and the point of movement to a flexible point that oscillates between the pedals, the handlebars and the seat.

Because of the abovementioned factors, riders are required to manoeuvre weight between two unstable platforms located on differing axes, the axes of which provide conflicting directions of energy transmission from the road surface when cornering and from the riders massive continually moving from the unstable pedals. In order to achieve the best possible results, riders must place the pedals as near as practical in one position for high lean angles, typically the inner pedal is placed at the top of the pedal stoke and the outer pedal at the base of the pedal stoke.

Even small environmental disturbances such as uneven road conditions displace the rider as well as forcing continual resetting of the balance position which is to be obtained by the rider absorbing these disturbances into their body and adjusting their body accordingly. Therefore, when cornering, the rider is required to provide stability for both axes through manipulation and control of muscles which requires greater skill and calculation of all the variables in order to successfully negotiate a corner.

The factors discussed above, and the stabilising efforts required greatly restrict a rider's ability to negotiate corners at high speed and further unnecessarily stress the friction surfaces of the bicycle tyres which result in loss of traction and crashes. It would be desirable to be able to lock the pedal crankshaft at various points on its rotational and therefore provide a secure platform for the rider when the rider is cornering.

Locking the crankshaft at various positions enables to the bicycle to provide a secure platform for the rider throughout the rotational axes of the crankshaft and facilitates the directions of energy transfer.

Locking the crankshaft enables the rider to locate their mass to the front or rear of the inner or outer pedals which enables traction to be enhanced for either the front or rear wheels as required. This can be achieved by locking the crankshaft in the appropriate position and applying a controlled lower body movement. These actions together further raise the cornering speed that a cyclist can achieve.

Additionally, the rider is no longer required to counterbalance any weight applied to an inner or outer pedal because the pedals are locked which further extends the range of pressure that a rider can apply.

Additionally, downwards force on the front and in particular, the front steering wheel can now be applied via the crankshaft into the frame which travels via the head stem directly down to the front axial. Because the unstable nature of the lower platform, i.e. the crankshaft, is removed by locking the crankshaft, the rider is able to focus their attention accurately on steering the bicycle through the handlebars to minimise the disturbance and achieve a smooth trajectory of the bicycle when cornering.

Accordingly it is an object of the present invention to address the foregoing problems or at least to provide the public with a useful choice.

### SUMMARY OF THE INVENTION

In a first aspect the present invention consists of a bicycle crankshaft lock comprising means for locking rotation of said bicycle crankshaft, and an actuator to move said means for locking rotation between a operative and inoperative condition, said actuator being hand operated. In an alternative first aspect, there is provided a bicycle crankshaft lock comprising a lock engageable with the crankshaft of a bicycle, the bicycle crankshaft rotatable when the lock is moved to a crankshaft non-engaged position, the lock inoperative condition, and the bicycle crankshaft non-rotatable when the lock is moved to an crankshaft engaged position, the lock operative condition, and wherein an actuator is connectable to the lock and operable to engage the lock with the crankshaft between the inoperative and operative conditions, the actuator being hand operable by a user.

Preferably said actuator can move said means for locking in at least one direction between said operative and inoperative conditions.

Preferably movement of said actuator in a second direction is effected by biasing means; preferably said biasing means is a spring.

Preferably said actuator can move said means for locking in two directions between said operative and inoperative conditions.

Preferably said means for locking rotation of said bicycle crankshaft is an interference brake for locking said crankshaft.

Preferably said means for locking rotation of said bicycle crankshaft includes a pin engagable in at least one cog to lock said crankshaft. More preferably, the cog may comprise of one or a series of one or more recesses or grooves or slots forming said cog. Alternatively, said means for locking rotation of said bicycle crankshaft includes at least one pin engagable in at least one cog to lock said crankshaft.

In a further alternative, the pin may preferably be a spine or projection extending from a locking means received within the bicycle's seat post and engageable with the at least one cog to lock said crankshaft. More preferably, the locking means may be in a cammed relationship with the internal frame of the seat post. Even more preferably, the locking means may be actuated to move between the operative and inoperative conditions via the actuator means. Preferably in an operative condition, the locking means may be actuated allowing a spine or projection to be extended or extend to engage within the recess or groove or slot of the crankshaft. Advantageously, in this manner the locking means can lock the crankshaft, or a collar secured to the crankshaft, in a locked condition or fixed position.

Preferably said means for locking rotation of said bicycle crankshaft includes a brake operable on said crankshaft for locking said crankshaft.

Preferably said brake operable on said crankshaft is a friction brake.

Preferably said friction brake is a band brake operable on said crankshaft.

Preferably said friction brake is a shoe brake operable on a drum attached to said crankshaft.

Preferably said friction brake is a disk brake operable on a disk attached to said crankshaft.

Preferably said actuator comprises a link connect to said means for locking rotation of said bicycle crankshaft; and a control assembly operable by a user.

Preferably said link is a cable, said control assembly is a cable control assembly including a user operable lever.

In an alternative embodiment, preferably the actuator may comprise of a magnetic actuator system, the system including one or more first magnets that provides a first polarity in or on or formed in at least a part of the means for locking rotation of the bicycle crankshaft, and one or more other magnets that provides the same or a different polarity to the first magnets, the polarity of the other magnets controllable via a control assembly operable by a user, wherein the first and other magnets are configured to magnetically interfere or interact or both with one another, such that, in use, the other magnets polarity's are controllable to move the means for locking rotation of the bicycle crankshaft between an operative and an inoperative condition.

Preferably, the one or more first magnets may be spaced about the means for locking rotation of the crankshaft. More preferably, the first magnets may be equally spaced about a circumference of the means for locking.

Preferably, the means for locking may be moveable along the crankshaft, an operative condition locking the crankshaft in fixed rotated position.

More preferably, in the operative condition an inside surface of the means for locking may be engageable with the crankshaft, even more preferably engageable with one or more projections or one or more, recesses of the crankshaft. Yet more preferably, the projection or recess of the crankshaft may for example one or more of a part or parts of a cog or cogs or spline or splines or tine or tines about the crankshaft, sympathetic engageable portions being provided on the inside surface of the means for locking.

Even more preferably, in the operative condition an outer surface of the means for locking may be engageable with an inside surface of a fixed structure within which the means for locking and is to be housed and through which the means for locking is moveable. Most preferably, the means for locking may be moveable along the crankshaft, in the operative condition the means for locking may be engageable with the crankshaft and the inside surface of the fixed structure within which the means for locking is to be housed. Preferably, the outer surface of the means for locking may be provided with four equally spaced recesses, the recesses each adapted to receive a lug or rods the lugs or rods engageable with four similarly spaced recesses provided on the inside surface of the fixed structure.

Preferably, the lock is keyed with a static part to prevent lock rotation. More preferably, the static part is a non-moving part of the bicycle. Alternatively, the static part is a bottom bracket of the bicycle, or is a sheath surrounding the lock and fixed relative a bottom bracket, or is a housing within which the lock is operatively moved by the actuator, or the static part is a fixed structure of the bicycle. In other alternatives, the static part is one or more of a combination of the static parts mentioned above.

Preferably, the means for locking may be moveable along the crankshaft, an inoperative condition allowing free rotation of the crankshaft.

More preferably, in the inoperative condition an inside surface of the means for locking may be non-engageable with a projection or recess of the crankshaft.

Even more preferably, in the inoperative condition an outer surface of the means for locking may be non-engageable with an inside surface of a fixed structure within which the means for locking and is to be housed and through which the means for locking is moveable. Most preferably, the means for locking may be moveable along the crankshaft, in the inoperative condition the means for locking may be non-engageable with the crankshaft and the inside surface of the fixed structure within which the means for locking is to be housed.

Preferably, the one or more first magnets are permanent magnets.

Preferably, the one or more other magnets are electromagnets. More preferably, the electromagnets may be charged or are chargeable, such that, magnetic interference between the first magnets and the other magnets moves the means for locking between the inoperative and operative condition, or between the operative and inoperative condition.

Preferably, the means for locking is a collar. More preferably, the collar has an inside surface engageable with an outside surface of the crankshaft. Most preferably, the inside surface of the collar has a series of projections and recesses engageable with a series of projections and recesses of an outside surface of the crankshaft.

Preferably, the link is a device, such as a switch, for user adjustment or control of the polarity of the one or more other magnets. More preferably, the link is an electromagnetic controller of the one or more other magnets.

Preferably said crankshaft is lockable in a plurality of positions.

Preferable said lockable positions includes a position wherein the peddle on the inside of the bicycle, when said bicycle is turning is locked substantially at the top of its rotation, and the peddle on the opposite side is locked substantially at the bottom of its rotation.

Preferable said lockable positions includes at least one position wherein said peddle crankshaft are substantially parallel to an axis between the axles of said front and rear wheels.

In a second aspect the invention may be broadly said to consist in a bicycle cornering system comprising a crankshaft locking mechanism, said locking mechanism including an actuator for moving said crankshaft locking mechanism between an operative and inoperative condition, to lock said crankshaft, said actuator being hand operated.

Preferably said actuator can move said locking mechanism in at least one direction between said operative and inoperative conditions.

Preferably movement of said actuator in a second direction is effected by a biasing device; preferably said biasing device is a spring.

Preferably said actuator can move said locking mechanism in two directions between said operative and inoperative conditions.

Preferably said locking mechanism to lock said crankshaft is an interference brake for locking said crankshaft.

Preferably said locking mechanism to lock said crankshaft includes a pin engagable in the axle of said crankshaft.

Preferably said locking mechanism to lock said crankshaft includes a pin engagable in at least one cog. More preferably, the cog may comprise of one or a series of one or more recesses or grooves or slots forming said cog. Alternatively, said locking mechanism to lock rotation of said bicycle crankshaft includes at least one pin engageable in at least one cog to lock.

In a further alternative, the pin may preferably be a spine or projection extending from a locking mechanism received within the bicycle's seat post and engageable with the at least one cog to lock said crankshaft. More preferably, the locking mechanism may be in a cammed relationship with the internal frame of the seat post. Even more preferably, the locking mechanism may be actuated to move between the operative and inoperative conditions via the actuator mechanism. Preferably in an operative condition, the locking mechanism can be actuated allowing a spine or projection to be extended or extend to engage within the recess or groove or slot of the crankshaft. Advantageously, in this manner the locking mechanism can lock the crankshaft, or a collar secured to the crankshaft, in a locked condition or fixed position.

Preferably said locking mechanism to lock said crankshaft includes a brake operable on the axle of said crankshaft.

Preferably said brake operable on the axle of said crankshaft is a friction brake.

Preferably said friction brake is a band brake.

Preferably said friction brake is a shoe brake operable on a drum attached to said axle.

Preferably said friction brake is a disk brake operable on a disk attached to said axle.

Preferably said actuator comprises a link connect to said crankshaft locking mechanism; and a control assembly operable by a user.

Preferably said link is a cable, said control assembly is a cable control assembly including a user operable lever.

Preferably said crankshaft is lockable in a plurality of positions.

Preferable said lockable positions includes a position wherein the peddle on the inside of the bicycle, when said bicycle is turning is locked substantially at the top of its rotation, and the peddle on the opposite side is locked substantially at the bottom of its rotation.

Preferable said lockable positions includes at least one position wherein said peddle crankshaft are substantially parallel to an axis between the axles of said front and rear wheels.

Preferably said actuator is a cable connecting said means for locking rotation of said bicycle crankshaft and a cable control assembly.

Preferably said cable control assembly is a lever.

Preferably the locking mechanism may be a user engageable device or system, such as for example the lever or a switch.

Preferably the user engageable device or system may be located or locatable on handle bars or stem or part of the bicycle within reach of a user during use of the bicycle.

In an alternative embodiment, preferably the actuator may comprise of a magnetic actuator system, the system including one or more first magnets of a first polarity in or on or formed in at least a part of the locking mechanism, and one or more other magnets of the same or a different polarity to the first magnets, the polarity of the other magnets controllable via a control assembly operable by a user, wherein the first and other magnets are configured to magnetically interfere with one another, such that, in use, the other magnets polarity's are controllable to move the locking mechanism between an operative and an inoperative condition.

Preferably, the one or more first magnets may be spaced about the locking mechanism. More preferably, the first magnets may be equally spaced about a circumference of the locking mechanism.

Preferably, the locking mechanism may be moveable along the crankshaft, an operative condition locking the crankshaft in fixed rotated position.

More preferably, in the operative condition an inside surface of the locking mechanism may be engageable with the crankshaft, even more preferably engageable with one or more projections or one or more recesses of the crankshaft. Yet more preferably, the projection or recess of the crankshaft may for example one or more of a part or parts of a cog or cogs or spline or splines or tine or tines about the crankshaft, sympathetic engageable portions being provided on the inside surface of the locking mechanism.

Even more preferably, in the operative condition an outer surface of the locking mechanism may be engageable with an inside surface of a fixed structure within which the locking mechanism is to be housed and through which the locking mechanism is moveable. Most preferably, the locking mechanism may be moveable along the crankshaft, in the operative condition the locking mechanism may be engageable with the crankshaft and the inside surface of the fixed structure within which the means for locking is to be housed. Preferably, the outer surface of the locking mechanism may be provided with four equally spaced recesses, the recesses each adapted to receive a lug or rods the lugs or rods engageable with four similarly spaced recesses provided on the inside surface of the fixed structure.

Preferably, the locking mechanism may be moveable along the crankshaft, an inoperative condition allowing free rotation of the crankshaft.

More preferably, in the inoperative condition an inside surface of the locking mechanism may be non-engageable with a projection or recess of the crankshaft.

Even more preferably, in the inoperative condition an outer surface of the locking mechanism may be non-engageable with an inside surface of a fixed structure within which the locking mechanism is to be housed and through which the locking mechanism is moveable. Most preferably, the locking mechanism may be moveable along the crankshaft, in the inoperative condition the locking mechanism may be non-engageable with the crankshaft and the inside surface of the fixed structure within which the locking mechanism is to be housed.

Preferably, the one or more first magnets are permanent magnets.

Preferably, the one or more other magnets are electromagnets. More preferably, the electromagnets may be charged or are chargeable, such that, magnetic interference between the first magnets and the other magnets moves the locking mechanism between the inoperative and operative condition, or between the operative and inoperative condition.

Preferably, the locking mechanism is a collar. More preferably, the collar has an inside surface engageable with an outside surface of the crankshaft. Most preferably, the inside surface of the collar has a series of projections and recesses engageable with a series of projections and recesses of an outside surface of the crankshaft.

Preferably, the link is a device, such as a switch, for user adjustment or control of the polarity of the one or more other magnets. More preferably, the link is an electromagnetic controller of the one or more other magnets.

Preferably, the one or more first magnets extend from a first end to a second opposite end of the locking mechanism. Preferably, the one or more other magnets are provided as a first electromagnetic device located in a magnetic interference position with the first end of the locking mechanism, and as a second electromagnetic device located in a magnetic interference position with the second end of the locking mechanism.

In a third aspect the invention consists in a method of locking a crankshaft in a fixed rotated position, the method comprising the steps of actuating the bicycle crankshaft lock as defined in the first or the second aspects above.

In a further aspect, the invention consists of a bicycle crankshaft lock comprising a lock engageable with the crankshaft of a bicycle, the bicycle crankshaft rotatable when the lock is moved to a crankshaft non-engaged position, the lock inoperative condition, and the bicycle crankshaft non-rotatable when the lock is moved to an crankshaft engaged position, the lock operative condition, and 10 wherein an actuator is connectable to the lock and operable to engage the lock with the crankshaft between the inoperative and operative conditions, the actuator being hand operable by a user, wherein the actuator comprises of a magnetic actuator system, the system including one or more first magnets providing a first polarity associated with at least a part of the lock engageable with the crankshaft, and one or more other magnets providing the same or a different polarity to the first magnets, the polarity of the other magnets controllable via a control assembly operable by a user, and wherein the first and other magnets are configured to magnetically interfere with one another, such that, in use the other magnets polarity is controllable to move the lock between a crankshaft engaged position, the lock operative condition, and a crankshaft non-engaged position, the inoperative condition.

In further aspect, there is provided an unassembled bicycle crankshaft lock comprising the lock as defined in any of the above aspects. In another aspect there is provided a bicycle cornering system comprising the bicycle crankshaft lock as defined in any of the above aspects. In yet a further aspect there is provided a bicycle comprising the bicycle crankshaft lock as defined in any of the above aspects. In another aspect there is provided a use of the bicycle crankshaft lock as defined in any of the above aspects. In still a further aspect there is provided a method of locking a bicycle crankshaft in a fixed rotated position, comprising engaging the bicycle crankshaft lock with the crankshaft of the bicycle as defined in any of the above aspects.

It should be appreciated an inter-locking of the lock engageable with the crankshaft and the crankshaft provides for preventing rotation of the crankshaft and in turn the bicycle peddles are prevented from rotation. In a configuration where the lock engageable with the crankshaft is not inter-locked with the crankshaft the crankshaft is able to rotate and in turn the bicycle peddles are free to be rotated.

This invention may also be said broadly to consist in the parts, elements and features referred to or indicated in the, specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Reference will now be made to a preferred form of the present invention in which:

FIG. 1 is a partial cross section of a bicycle crankshaft of an exemplary embodiment of the present invention, from the front of a bicycle;

FIG. 2 is a partial cross section of a bicycle crankshaft of a further exemplary embodiment of the present invention, from the front of a bicycle;

FIG. 3 is an enlarged partial view of FIG. 1 showing the crankshaft locking mechanism;

FIG. 4 is an enlarged partial view of FIG. 2 showing the crankshaft locking mechanism;

FIG. 5 is an enlarged partial view of FIG. 1 showing a locked crankshaft;

FIG. 6 is a side partial cross section of a further exemplary embodiment of the present invention;

FIG. 7 is an exemplary controller for controlling the crankshaft locking means;

FIGS. 8A, 8B and 8C show one exemplary embodiment of a bicycle crankshaft lock according to the present invention,

FIG. 9 shows a further exemplary embodiment of a bicycle crankshaft lock according to the present invention, and

FIG. 10 shows yet a further embodiment of a bicycle crankshaft lock according to the present invention.

### DETAILED DESCRIPTION

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification, the features, prefaced by that term in each statement, all need to be present but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

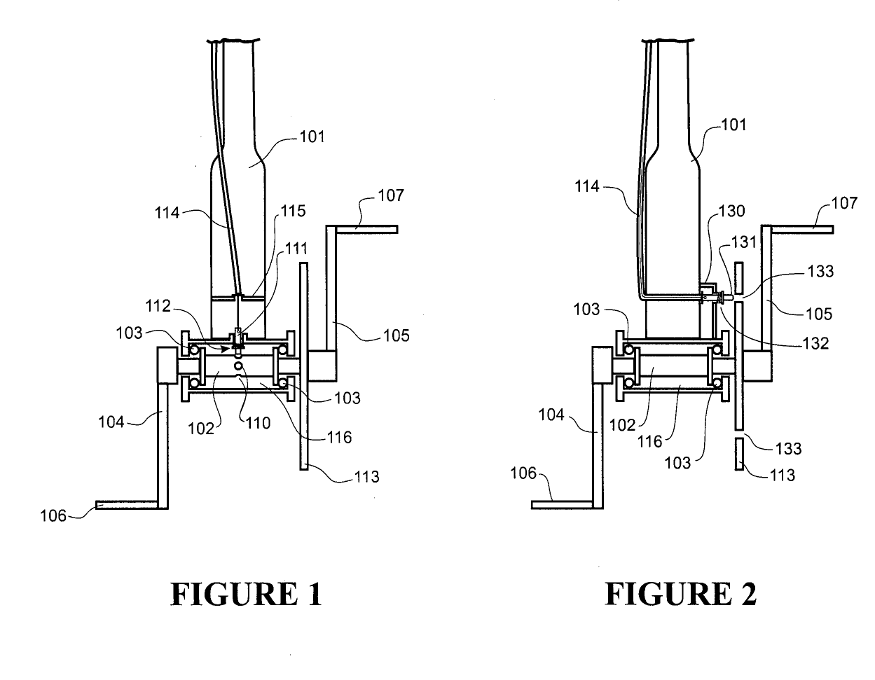

Referring to FIGS. 1 and 2 exemplarily embodiments of the present invention are illustrated. A bottom bracket 116 is located at the base of the seat post or tube 101 of the bicycle frame (not shown). The bottom bracket 116 provides a hollow to allow the axles unit of the crankshaft 102 to be mounted in bearings 103. The crankshaft axles 102 are attached to the cranks 104 and 105 which in turn are attached to pedals 106 and 107.

In FIG. 1, the crankshaft 102 has a plurality of apertures or holes 110 in to which a pin 111 can be inserted locking the crankshaft 102 and preventing movement of the pedals 106, 107. The apertures or holes 110 in the crankshaft 102 are preferably spaced at 90 degrees and aligned to allow the crankshaft to be locked with one pedal 107 at the top of its rotation while the second pedal 106 is at the bottom of its rotation. Other holes 110 allow for the pedals 106, 107 to be locked with the second peddle 106 at the top of its rotation. Further, the peddles 106, 107 may be locked halfway through the down stroke of a first pedal and alternatively halfway through the down stroke of a second pedal 106. The cable 114 can be for example, a Bowden-type cable, with a stop or nipple 115 for holding the sheath surrounding the cable 114.

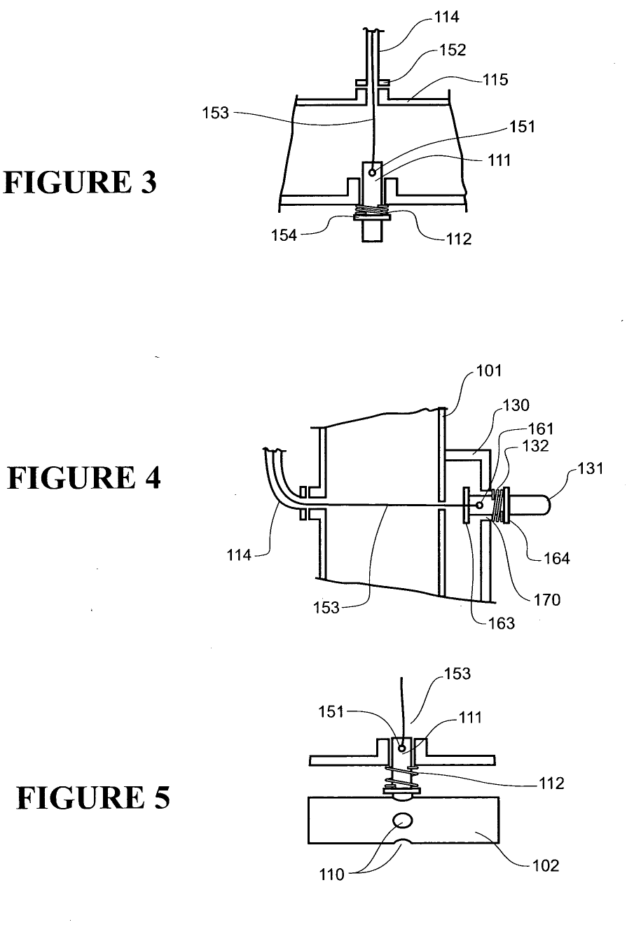

In more detail, referring to FIG. 3, the pin 111 is preferably located within the seat post or tube 101 of a bicycle frame (not shown) and protrudes through the bottom bracket 116 (not shown in FIG. 3, but shown in FIG. 1) and is biased towards insertion of the pin 111 in to one of the pluralities of apertures or holes 110 in said crankshaft 102 (also not shown, but detailed in FIG. 1). The bias means in one embodiment is a spring 112, a circlip 154 secures the spring 112 in place. A cable 153 connects to the pin 111 at a connection point 151 and at an other end of the cable 114 to a controller 200 illustrated in FIG. 7. A flange 152 of the cable 114 helps secure the cable 114 in place. The controller 200 allows a user to release the cable 114 allowing the pin bias means 112 to force the pin 111 into an aperture or hole 110. The cable 114 can for example, be a Bowden-type cable, with the stop or nipple 115 for holding the sheath surrounding the cable 153.

FIG. 5 illustrates the pin 111 engaged with an aperture or hold 110 in a crankshaft 102 located in position via the bias means 112 being a spring and held in position via a circlip. A centre cable 153 is shown connected to the pin 111 at a connection or attachment point 151.

In FIG. 2, there is shown an alternative configuration to that shown in FIG. 1. The cable 114 can be actuated to move a pin 131 into an aperture or hole 133.With reference also to FIG. 4, a seat shaft 101 has a frame 130 attached. The frame 130 has the pin 131 protruding through a hole 170. A spring 132 is secured by a circlip 164 or other securing means such as a ring and washer or nut. A flange 163 on the opposite side of the hole 170 limits the movement of the pin 131. The spring 132 biases the pin 131 in the direction of the hub 113. A cable 114 having a centre cable 153 is locked tight with the pin 131 pulled back. The centre cable 153 is connected or attached at a connection point 161 to the pin 131. When a user wishes to lock the hub 113 the user releases the cable 153 allowing the bias means 132 to bias the pin 131 in to an aperture or hole 133 in the hub 113, the hub 113 being secured to the crankshaft 102.

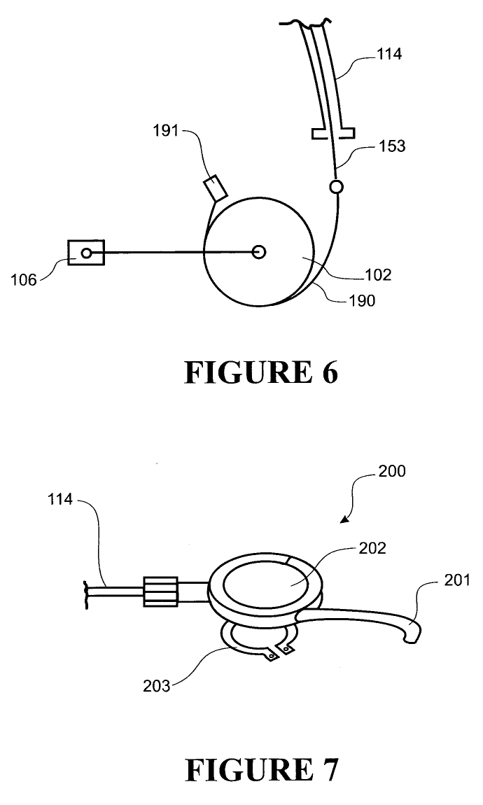

Referring to FIG. 6, a further alternative is illustrated. A band brake 190 surrounds the crankshaft 102. The band brake 190 may either be located within the bottom bracket 116 or may be located outside the bottom bracket 116 but around the crankshaft 102. The band brake 190 is secured at a first end and to a cable 114 having a centre cable 153, at a second end. The cable 153 is tightened by a hand controller 200 to control and lock the crankshaft.

Other alternative brakes or friction brakes include disk brakes that may be used. For example a disk can be secured to the crankshaft 102 and disk pads lock and secure the disk in response to a user control. Further embodiment includes the use of a hub brake having shoes and a hub secured to the crankshaft 102 wherein a user actuates the shoes to secure the hub and thereby secure the crankshaft 102.

While a cable mechanism has been illustrated, alternatively, a link may be used to secure the brakes, activate the interference brake, or to locate the pins for securing the crankshaft 102. A mechanical link may be used to connect the user control assembly and the various crankshaft 102 locking or breaking options. A mechanical link will allow the brake to be moved between a locking and unlocked position by a user using the control assembly. When a cable is used biasing means such as a spring are used to move the brake in one direction while the cable is used to move the brake in the other direction.

It is desirable that the crankshaft 102 can be locked in a number of positions. The preferred positions include a first position wherein, the pedal on the inside turning corner direction is located at the top of its rotation while the other pedal on the opposite side is located at the bottom of its rotation. Other positions include having the pedals substantially parallel to an axis between the front and rear hubs of the front and rear wheels. Using a disk or friction brake has the advantage of allowing the crankshaft to be locked in any position allowing the user to adjust their position to obtain an ideal position for their turning style. While the use of a pin in either the crankshaft or a cog or hub has the advantage of being simple the number of positions that the wheel can be locked in is limited by the number of locating holes that can be drilled or machined in the cogs or the crankshaft 102.

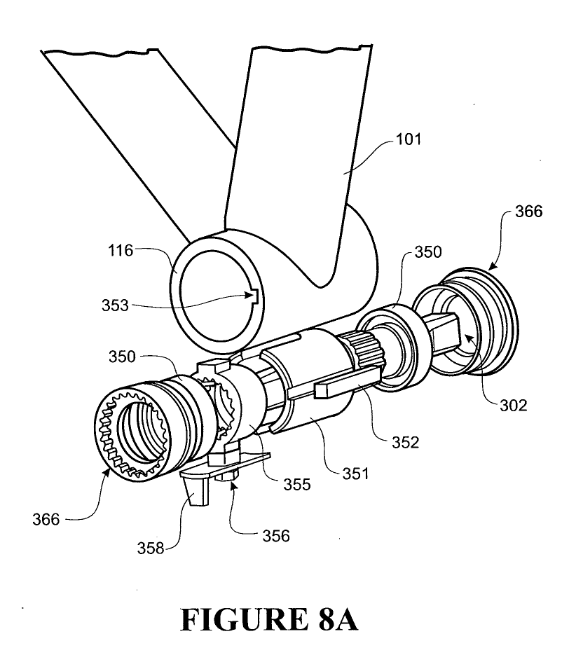

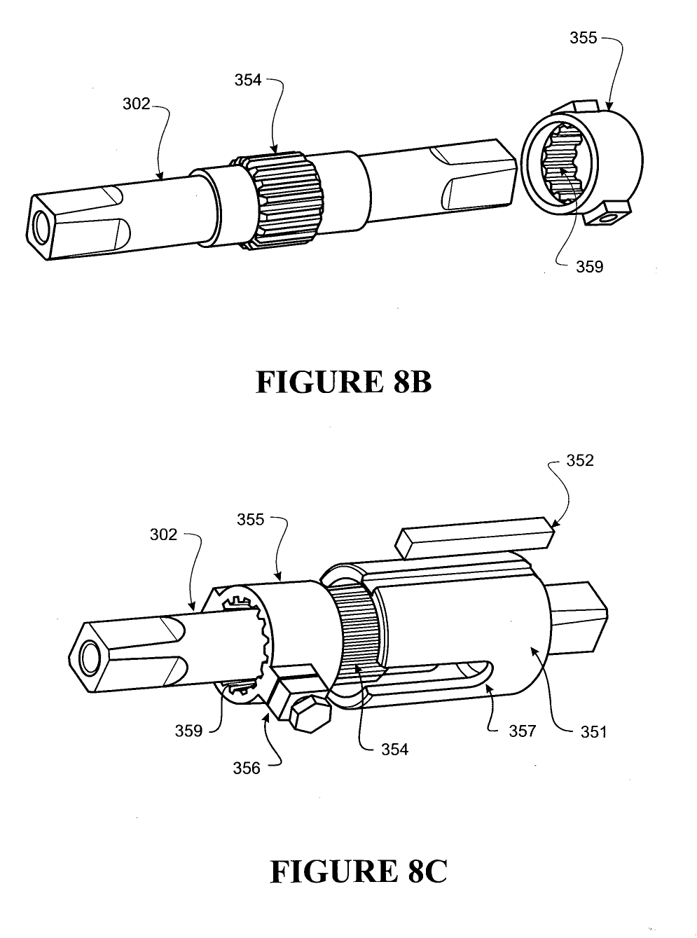

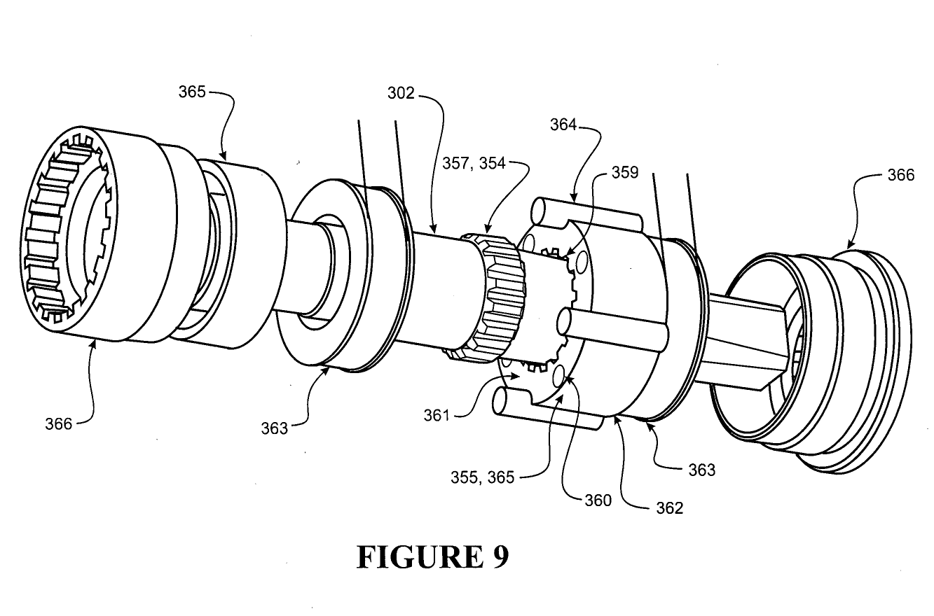

FIGS. 8A, 8B and 8C illustrate various components of an alternative embodiment to those previously described.

FIG. 8A shows a seat post or tube 301 and a bottom bracket 316. Components which fit within and extend through the bottom bracket 316 are shown in a displaced arrangement. For example, a crankshaft 302 is used to locate a pair of bearings 350, a fixed structure or housing or sheath 351. The fixed structure or housing or sheath 351 includes a pin, lug, rail or spline 352 to be engaged with a recess 353, such as for example an existing bearing mounting, for receiving the spline 352 and holding the fixture structure or housing or sheath 351 in place. The crankshaft 302 has a cogged arrangement or set of projections or tines 354 extending from the outer surface of the shaft 302. A cogged arrangement means one or more of a series of projections and recesses about a part of whole of the circumference of the shaft or a collar.

A locking mechanism, lock 355, is moveable long the crankshaft 302 between an inoperative and operative condition. The locking mechanism 355 includes a set of projections or tines and recesses, such as a cog or gearing, on its inside surface that are adapted to engage with the projections and recesses extending from the outer surface of the crankshaft 302. The lock 355 can be of the form of a collar surrounding the crankshaft, for example as shown in FIG. 8C and an exploded form as shown in FIG. 8B.

In an operative condition, the inside surface locking mechanism 355 is in an engaged position with the outer surface of the crankshaft 302. In such a situation the locking mechanism 355 has a locking portion 356 that moves in engagement with a recess 357 and prevents the crankshaft 302 from being rotatable. The locking mechanism 355 is actuated via a cable (not shown) that can manually be connected to a connector 358 and hand controlled, similar to the actuators illustrated in FIGS. 1-7. Other components shown in FIG. 8A relate to adaptor parts for connecting to peddles or chain rings of a bicycle or intermediate parts thereof.

FIG. 9 illustrates yet another embodiment of the invention. Shown is a crankshaft 302, with a series of projections and recesses, such as tines 354 on the shaft 302. Also shown is a locking mechanism 355 that is moveable between an operative and inoperative condition.

The locking mechanism has an inner surface of which includes a series of recesses and projections 359 engageable with an outer surface of the crankshaft 302 having complimentary projections and recesses 354. In an operative condition the locking mechanism's inner surface 359 is in engagement with the outer surface 354 of the crankshaft 302.

The locking mechanism 355 is moveable between the operative condition and inoperative conditions via influence of magnetic forces. Shown are a first magnets 360 at a first end or side of the locking mechanism 355. Although not shown, the first magnets 360 extend from the first end or side 361 of the locking mechanism 355 to the other opposite end or side 362 of the locking mechanism 355. The magnets are of a fixed polarity, for example the first end 361 can be North polarity and the second end 362 can be the South polarity, or vice versa. Alternatively, magnets can be provided at each end 361, 362 of the locking mechanism 355 in any polarity orientation, such that the polarities of the first magnets 360 and the second magnets 363 are able to interfere or in an interference pattern with each other. In yet a further alternative, the first magnets 361 can be electromagnets, charged from a power source (not shown).

The second magnets 363 being of an electromagnetic type, during use, can be energised or charged from a power source (not shown) to repel or attract the first magnets 361 and thus the locking mechanism 355, into a preferred position upon the crankshaft 302. For example, the second magnets 363 can be charged to move the locking mechanism into an operative position where the inner surface 359 engages with the outer surface 354. In that manner the locking mechanism has engaged with the crankshaft 302.

In various examples of the present embodiment, the locking mechanism 355 can be controlled via an actuator in the form of second electromagnets 363. The electromagnets can operate to move the locking mechanism 355 into an engaged operative position, alternatively they can operate to move the locking mechanism 355 into a non-engaged inoperative position, such as for example that shown in FIG. 9.

However, it should be appreciated that the embodiment illustrated by FIG. 9 may be varied. For example, the second magnets 363 may be arranged about the cranks shaft 302 such that the non-engaged inoperative condition is always located to one particular end of the crankshaft 302 with respect to the projections 354. Alternatively, depending on the space provided by the bottom bracket 116, the second magnets 363 can be arranged such that a non-engaged inoperative condition can be to either side of the projections 354 along the crankshaft 302.

The locking mechanism 355 also includes recesses for receiving one or more pins 364 extending from an outer surface 365 of the locking mechanism 355. The one or more pins 364 are located within sympathetic recesses (not shown) of the housing, such as a bottom bracket housing 116. In that manner the locking mechanism 355 is prevent from rotation. However, the pins 364 allow for the locking mechanism 355 to be moveable or slidable between the engaged operative and non-engaged inoperative conditions with the crankshaft 302 projections and recesses 357.

The actuator can comprise of a magnetic actuator system, the system including one or more first magnets 360 of a first polarity in or on or formed in at least a part of the locking mechanism 355, and one or more other magnets 363 of the same or a different polarity to the first magnets, the polarity of the other magnets controllable via a control assembly 200 operable by a user, wherein the first 360 and other magnets 363 are configured to magnetically interfere with one another. Such that, in use, the other magnets 363 polarity's are controllable to move the locking mechanism 355 between an operative and an inoperative condition. As illustrated, the one or more first magnets 360 are spaced about the locking mechanism 355, for example in the equally spaced arrangement, such as every 90° about a circumference of the locking mechanism 355.

As will be understood from the discussion above, the locking mechanism 355 is moveable along the crankshaft 302 to an operative condition that allows locking of the crankshaft 302 in fixed rotated position.

In the operative condition, an outer surface 365 of the locking mechanism 355 is engageable with an inside surface of a fixed structure, such as bottom bracket 116, within which the locking mechanism 355 is to be housed and through which the locking mechanism 355 is moveable. In the embodiment illustrated by FIG. 9, the outer surface 365 of the locking mechanism 355 is provided with four equally spaced recesses, the recesses each adapted to receive a lug or rod or rail or pin 364. The lug or rod or rail or pin 364 is engageable with four similarly spaced recesses provided on the inside surface of the fixed structure, such as the bottom bracket 116. Such a configuration prevents the locking mechanism 355 from rotating within the housing, i.e. the locking mechanism is rotationally static relative to the crankshaft 302 and the housing or bottom bracket 116. This allows the locking mechanism 355, when engaged with the crankshaft 355 in an operative condition to lock the crankshaft 302 from rotating. When the crankshaft 302 is prevented from rotation the bicycle's peddles are similarly unable to move. The peddles can therefore be locked into a desired position by the user by actuating the locking mechanism 355 into an operative condition.

It will be appreciated an inoperative condition allows free rotation of the crankshaft 302, for example when being rotated by forces inputted to peddles from a user of the bicycle.

Other parts illustrated by FIG. 9 can include bearings 365 and adapters 366 for connection with peddles (not shown) or cycle chain rings (not shown).

The second magnets 363 can be charged and their polarity controlled by a hand operated actuator device, for example a switch located on a bicycle's handlebars. Power can be provided to the first or second or both sets of magnets via a power source (not shown) such as for example, batteries, or a power generator connected to the bicycle wheel or other devices as will be appreciated for powering of bicycles where weight is a consideration.

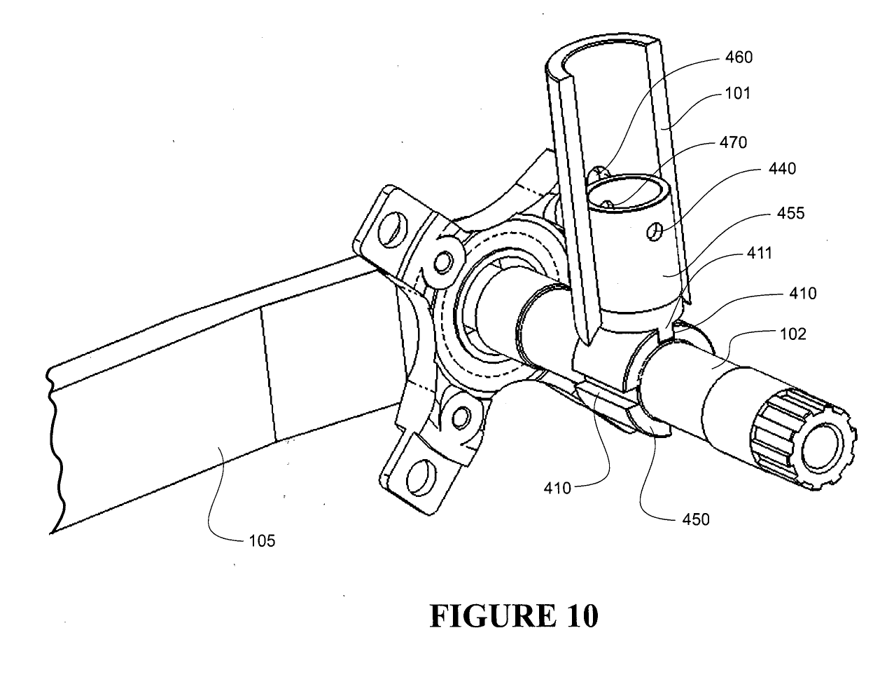

In another embodiment of the invention, as illustrated by FIG. 10, the bicycle crankshaft lock system can be provided by the bicycle's crankshaft 102 having been machined with one or a series of grooves or recesses or slots 410, such as in the form of a cog as previously described. Alternatively, the crankshaft 102 can be modified or fitted with a collar 450, as shown by FIG. 10, that is secured to the crankshaft 102, the collar 450 having one or a series of exterior grooves or recesses or slots 410. The grooves or recesses or slots 410 provide for the female side of a male-female type locking system, the male side of which can engage with or be inserted into the female side.

The grooves or recesses or slots 410 may be arranged about the circumference of the crankshaft 102 or collar 450, and may optionally be arranged such that they align with positions when the peddles of the bicycle (both left and right peddles) are in vertical-vertical positions or horizontal-horizontal positions (e.g. at 90° positions about the shaft). Alternatively, although not shown, there can be many more slots or grooves or recesses provided that can be engaged with. Such an alternative facilitates a user engaging the locking mechanism with the crank shaft 102 or collar 450 at different positions about the crank shaft, and therefore locking the position of the peddles at different positions.

In other embodiments, the relative position of the peddles (not shown) and the grooves or recesses or slots 410 can be adjusted by a user, for example as fine tuning of the crank locking system according to preferred peddle positions by the user. In this manner, a fitted collar 410 about the crank shaft may have benefit. The collar 410 can be fitted by a welded retro-fit to the shaft 102 or can be connected by other removeable devices, such as grub screws or the like.

The male side of the system is provided for by a pin or projection or spine 411 extending from the locking mechanism 455 that can be driven or actuated from within the seat post frame 101 to engage or be inserted into a correspondingly aligned groove or recess or slot 410 of the crankshaft 102 (or its collar 450 if fitted). Advantageously, the locking mechanism 455 is received within and, for example, can be in a cammed relationship within the seat post frame 101 enabling ease of movement of the locking mechanism 455 and alignment of the projection or spine 411 down into the crankshaft 102 or collar 450 grooves or recesses or slots 410. In this embodiment, the locking mechanism 455 is like a piston, it can be moved up out of an engaged position or moved down to engage with the shaft 102 or collar 450 to lock the crankshaft 102 in a fixed position.

The actuator (not specifically shown, but connected to locking mechanism 455) can be any of the actuators as previously described. One example is a biasing means (not shown), such as for example a spring that a user can activate to move the locking mechanism 455. Other examples include a cable or cables or other magnetically actuated system for moving the locking mechanism 455 between an inoperative position where the crankshaft 102 can rotate and between an operative position where the crankshaft is locked into a fixed position and not able to be rotated.

Engagement of the locking mechanism 455 with the crankshaft 102 secures the crankshaft 102 from rotation; likewise a non-engaged position allows the crankshaft 102 to be rotated by a user. The engaged or disengaged positions can be reached by an actuator moving the locking mechanism 455, for example in the form of a pre-tensioned spring and cable lever connected to the locking mechanism 455. The action of the lever activated can be reversed to engage or disengage the spring or lever to suit users specific needs of operation, i.e. between the operative and inoperative crank locking positions. Such a system can be actuated by a user from a remote position that suits the riders needs, such the handle bars. The end of the actuator system to be operated by a user can be positioned according to the user's comfort or preference, by the handle bars, on a portion of the bike frame, or from a hand-held device. Mechanisms for are described previously.

The entire mechanism can be mounted internally within the frame of a bicycle. For example, the locking mechanism 455 can be located in position by a cammed arrangement within the seat post 101. It will be appreciated bearings and other friction reducing systems (details not shown) can be employed to facilitate the ease of movement of the locking mechanism when being actuated between operative and inoperative positions with the crankshaft 102 or collar 450. The locking mechanism 455 can be appropriately shaped to slide up and down within the seat post frame on runners or other guides. In this manner, the locking mechanism 455 can be kept in an alignment of which the spine or projection 411 is always correctly aligned for engaging with a corresponding recess or groove or slot 410 of the collar 450 or shaft 102 or cog when presented to the locking mechanism 455.

The actuator can also be located within the frame of the bicycle, although it may also run externally of the frame. For example, a mechanical actuation system, such as for example a cable running to a hand grip or other device or lever for use by a user can be located by the handle bars. Likewise, a switching system, for example a switch for an electromagnetic actuation system can located by the handlebars (or another position as desired by a user) for switching or reversing the polarity of magnets that may be used to push or pull the locking mechanism between the operative and inoperative positions. Magnetic propulsion systems for use as the actuator such a described in the previous embodiments can be employed here too, but where magnetic system is incorporated into the seat post frame 101 (or other frame portion of the bicycle). The actuator can be connected via the aperture 440, although other connection systems are also contemplated.

In another form of the invention, the crank locking system can be fixed into an operative or inoperative position by affixing a grub screw or other device to prevent the locking mechanism from being actuated, such as by securing the locking mechanism 455 to seat post frame 101 via an opening or aperture 460 in the frame and a corresponding opening or aperture 470 in the locking mechanism 455. A locating pin or grub screw or a cam key can be used to lock in place the locking mechanism so it can not be actuated. In this manner the locking mechanism can be isolated from the crankshaft (and therefore the pedals) from any form of operation for extended periods if wanted. Such a form of the invention may be put in place as a security from a user inadvertently locking the crank.

It will be appreciated the embodiment above and as illustrated by FIG. 10 can be understood and complemented by the arrangement of FIGS. 1, 3, 5 and 7. Magnetic systems for actuating the embodiment of FIG. 10 can be employed, using the mechanisms described in the embodiments above and as illustrated by FIG. 9.

1. A bicycle crankshaft lock comprising a lock engageable with the crankshaft of a bicycle, the bicycle crankshaft rotatable when the lock is moved to a crankshaft non-engaged position, the lock inoperative condition, and the bicycle crankshaft non-rotatable when the lock is moved to a crankshaft engaged position, the lock operative condition, and wherein an actuator is connectable to the lock and operable to engage the lock with the crankshaft between the inoperative and operative conditions, the actuator being hand operable by a user.

2. The lock as claimed in claim 1, wherein operation of the actuator moves the lock engageable with the crankshaft in a first direction between the inoperative or operative condition and the operative or inoperative condition.

3. The lock as claimed in claim 2, wherein a biasing device operates to move the lock engageable with the crankshaft in a second direction, between the operative or inoperative condition and the inoperative or operative condition.

4. The lock as claimed in claim 3, wherein the biasing device is a spring, such as a helical spring.

5. The lock as claimed in claim 1, wherein operation of the actuator moves the lock engageable with the crankshaft between both the inoperative and operative conditions.

6. The lock as claimed in claim 1, wherein the lock engageable with the crankshaft includes a brake operable on the crankshaft for locking the crankshaft.

7. The lock as claimed in claim 6, wherein the brake is an interference brake.

8. The lock as claimed in claim 6, wherein the brake is a friction brake selected from one or a combination of the following: a band brake operable on the crankshaft, a shoe brake operable on a drum attached to the crankshaft, a disk brake operable on a disk attached to the crankshaft.

9. The lock as claimed in claim 6, wherein the friction brake is a band brake operable on the crankshaft.

10. The lock as claimed in claim 6, wherein the friction brake is a shoe brake operable on a drum attached to the crankshaft.

11. The lock as claimed in claim 6, wherein the friction brake is a disk brake operable on a disk attached to the crankshaft.

12. The lock as claimed in claim 1, wherein the crankshaft includes at least one aperture and the lock includes a pin engageable with the apertures.

13. The lock as claimed in claim 1, wherein at least a part of the crankshaft includes at least one aperture and the lock includes a pin engageable with the apertures.

14. The lock as claimed in claim 12, wherein the pin is engageable with the at least one aperture when at least one of the apertures is aligned with the pin.

15. The lock as claimed in claim 1, wherein the crank shaft includes at least one cogged portion and the lock includes a pin engageable with at least one of the crankshaft cogged portions.

16. The lock as claimed in claim 15, wherein the cogged portion comprises of one or a combination of a series of one or more of recesses, grooves, slots forming the cogged portion.

17. The lock as claimed in claim 15, wherein the pin is engageable with at least one of the cogged portions when the cogged portions is aligned with the pin.

18. The lock as claimed in claim 12, wherein the pin is selected from a spine or a projection, the pin extendable from within the bicycle's seat port.

19. The lock as claimed in claim 12, wherein in the lock operative condition the pin is extended to engage the at least one aperture or at least one of the cogged portions of the crankshaft, and at the lock inoperative condition the pin is retracted to withdraw, or disengage, from the at least one aperture or at least one cogged portions of the crankshaft.

20. The lock as claimed in claim 1, wherein the lock is journalled substantially within the seat post's internal frame.

21. The lock as claimed in claim 1, wherein an inside surface of the lock has one or more of a series of cogged portions engageable with a corresponding one or more of a series of cogged portions about the crankshaft.

22. The lock as claimed in claim 21, wherein in the operative condition the inside surface of the lock is engaged with the crankshaft and the outside surface of the lock is keyed with a static part to prevent lock rotation.

23. The lock as claimed in claim 21, wherein the outer surface of the lock is provided with four equally spaced recesses, the recesses each adapted to receive a lug or rod, the lug or rod engageable with four similarly spaced recesses provided in the inside surface of the static part.

24. The lock as claimed in claim 22, wherein the lock is keyed with a static part to prevent lock rotation.

25. The lock as claimed in claim 23, wherein the static part is a non-moving part of the bicycle.

26. The lock as claimed in claim 23, wherein the static part is a bottom bracket of the bicycle.

27. The lock as claimed in claim 23, wherein the static part is a sheath surrounding the lock and fixed relative a bottom bracket.

28. The lock as claimed in claim 23, wherein the static part is a housing within which the lock is operatively moved by the actuator.

29. The lock as claimed in claim 23, wherein the static part is a fixed structure of the bicycle.

30. The lock as claimed in claim 21, wherein the lock is located about and slidable along the crankshaft.

31. The lock as claimed in claim 21, wherein the lock is slidable along the crankshaft between operative and inoperative conditions by operation of the actuator.

32. The lock as claimed in claims 21, wherein in the inoperative condition the lock and crankshaft are non-engaged.

33. The lock as claimed in claim 21, wherein the lock is a collar.

34. The lock as claimed in claim 33, wherein the lock has an inside surface engageable with an outside surface of the crankshaft.

35. The lock as claimed in claim 34, wherein the inside surface of the collar has a series of projections and recesses engageable with a series of projections and recesses of an outside surface of the crankshaft.

36. The lock as claimed in claim 1, wherein the actuator comprises of a magnetic actuator system, the system including
one or more first magnets providing a first polarity associated with at least a part of the lock engageable with the crankshaft, and
one or more other magnets providing the same or a different polarity to the first magnets, the polarity of the other magnets controllable via a control assembly operable by a user,
wherein the first and other magnets are configured to magnetically interfere with one another, such that, in use the other magnets polarity is controllable to move the lock between a crankshaft engaged position, the lock operative condition, and a crankshaft non-engaged position, the inoperative condition.

37. The lock as claimed in claim 36, wherein the one or more first magnets are spaced about the lock engageable with the crankshaft.

38. The lock as claimed in claim 36, wherein the first magnets are spaced about a circumference of the lock, preferably equally spaced.

39. The lock as claimed in claim 36, wherein the one or more first magnets are permanent magnets.

40. The lock as claimed in claim 36, wherein the one or more other magnets are electromagnets.

41. The lock as claimed in claim 40, wherein the electromagnets are charged or are chargeable, such that, magnetic interference between the first magnets and the other magnets moves the lock between the inoperative and operative condition, or between the operative and inoperative condition.

42. The lock as claimed in claim 1, wherein the actuator comprises a link connected to the lock engageable with the crankshaft and a control assembly operable by a user.

43. The lock as claimed in claim 42, wherein the link is a cable and the control assembly is a cable control assembly including a user operable lever.

44. The lock as claimed in claim 42, wherein the link is a device, such as a switch, for user adjustment, or control, of the polarity of one or more magnets.

45. The lock as claimed in claim 42, wherein the link is an electromagnetic controller of the polarity of one or more other magnets.

46. The lock as claimed in claim 1, wherein the crankshaft is lockable in a plurality of positions.

47. The lock as claimed in 46, wherein the lockable positions includes a position wherein the peddle on the inside of the bicycle, when the bicycle is turning, is locked substantially at the top of its rotation, and the peddle on the opposite side of the bicycle is locked substantially at the bottom of its rotation.

48. The lock as claimed in claim 46, wherein the lockable positions includes at least one position wherein the peddle crankshaft are substantially parallel to an axis between the axles of the front and rear bicycle wheels.

49. The lock as claimed in claim 1, wherein the lock is moveable between the operative and inoperative conditions via operation of the actuator.

50. A bicycle crankshaft lock comprising a lock engageable with the crankshaft of a bicycle, the bicycle crankshaft rotatable when the lock is moved to a crankshaft non-engaged position, the lock inoperative condition, and the bicycle crankshaft non-rotatable when the lock is moved to an crankshaft engaged position, the lock operative condition, and wherein an actuator is connectable to the lock and operable to engage the lock with the crankshaft between the inoperative and operative conditions, the actuator being hand operable by a user, wherein the actuator comprises of a magnetic actuator system, the system including one or more first magnets providing a first polarity associated with at least a part of the lock engageable with the crankshaft, and one or more other magnets providing the same or a different polarity to the first magnets, the polarity of the other magnets controllable via a control assembly operable by a user, and wherein the first and other magnets are configured to magnetically interfere with one another, such that, in use the other magnets polarity is controllable to move the lock between a crankshaft engaged position, the lock operative condition, and a crankshaft non-engaged position, the inoperative condition.

51. (canceled)

52. (canceled)

53. (canceled)

54. (canceled)

55. A bicycle comprising the bicycle crankshaft lock as defined in claim 1.

56. (canceled)

57. (canceled)

58. (canceled)
